(19) United States
(12) Patent Application Publication
(10) Pub. No.: US 2026/0234968 A1
(43) Pub. Date: Aug. 13, 2026

(54) CONTROL ASSEMBLY FOR OPERATING A MOTOR VEHICLE LOCKING SYSTEM

(71) Applicant: Brose Fahrzeugteile SE & Co. Kommanditgesellschaft, Bamberg, Bamberg (DE)

(72) Inventors: Florian Pohl, Ebersdorf (DE); Alexander Mueller, Bischberg (DE); David Weinkamm, Hallstadt (DE); Rene Bekendam, Remscheid (DE)

(21) Appl. No.: 19/471,106

(22) PCT Filed: Mar. 21, 2024
(86) PCT No.: PCT/EP2024/057551

§ 371 Date: Sep. 30, 2025

(30) Foreign Application Priority Data
Apr. 3, 2023 (DE) 10 2023 108 477.1

(51) Int. Cl. E05B 81/86; E05B 81/06

(52) U.S. Cl. CPC E05B 81/86; E05B 81/06

(57) ABSTRACT

A control arrangement for operating a motor vehicle locking system, wherein the motor vehicle locking system has a drive having an electric drive motor, wherein the control arrangement, in response to detection of an operating event by means of an operating element, controls the drive to provide a motorized locking function for an adjustable closure element of the motor vehicle, wherein the control arrangement has an electrical energy store, wherein the energy store provides an electrical energy store voltage for providing an electrical emergency supply voltage for the electric drive in an emergency mode, in particular if a normal supply voltage for the motor vehicle fails. It is proposed that the control arrangement has a timing circuit which in the emergency mode connects an operating element supply voltage from the energy store to the operating element during certain periods of time.

### CROSS-REFERENCE TO RELATED APPLICATIONS

This application is a national stage application under 35 U.S.C. 371 of International Patent Application Serial No. PCT/EP2024/057551, entitled “Control Assembly for Operating a Motor Vehicle Locking System,” filed Mar. 21, 2024, which claims priority from German Patent Application No. DE 10 2023 108 477.1, filed Apr. 3, 2023, the disclosure of which is incorporated herein by reference.

### FIELD OF THE TECHNOLOGY

Various embodiments relate to a control arrangement for operating a motor vehicle locking system, to a motor vehicle locking system and to a method for operating a motor vehicle locking system.

### SUMMARY

The motor vehicle locking system in question is used in all types of motorized locking functions for closure elements of a motor vehicle. These include in particular closure elements such as side doors, rear doors, tailgates, trunk lids, engine hoods or the like. These closure elements can be configured in principle as hinged doors or sliding doors. The motorized locking function relates in particular to a motor vehicle lock associated with the motor vehicle locking system. Further examples of the relevant locking functions of a motor vehicle are drive arrangements which provide motorized adjustment of the aforementioned closure elements.

DE 10 2020 102 775 A1, on which various embodiments are based, relates to the operation of a motor vehicle locking system having a motor vehicle lock that has a lock latch and a pawl as locking elements. The lock latch can be moved into a closed position in which it is in holding engagement with the locking part and in which it is fixed by the pawl. The motor vehicle lock is also equipped with an electric drive that can be used to lift the pawl such that the lock latch can be adjusted in its open position, releasing the locking part.

In order to take into account the requirements in terms of the reliability of the voltage supply for such motor vehicle locks, the known control arrangement has a rechargeable energy store, as a result of which the electrical energy supply for the motor vehicle locking system is ensured via an emergency supply voltage even in an emergency mode, in particular if a normal supply voltage fails.

Various embodiments are based on the problem of configuring and developing a control arrangement for operating a motor vehicle locking system in such a way that the use of the motor vehicle locking system in the emergency mode is further optimized.

The above problem is solved by various features provided herein.

The crucial factor is the fundamental consideration that further components of the vehicle locking system can also be operated using the energy store of the control arrangement for the motor vehicle locking system, which is provided for the emergency supply of the drive. An operating element, which has, for example, a sensor arrangement for detecting actuation via a key check, is also supplied here with electrical energy in the emergency mode via the energy store.

In particular, it is proposed that the control arrangement has a timing circuit which in the emergency mode connects an operating element supply voltage from the energy store to the operating element during certain periods of time.

Particular importance is attached here to the connection of the operating element supply voltage during certain periods of time, thus avoiding premature discharging of the energy store via the operating element while simultaneously maintaining the functionality of the operating element.

In various embodiments, the energy store has at least one capacitor and a boost arrangement, thus making it possible to provide a high power density for the motor vehicle locking system.

In various embodiments, the operating element can be provided with the capacitor voltage itself, wherein the boost arrangement is activated in particular only when required, for example when the drive is tripped.

In various embodiments, the boost arrangement can also further serve to provide the operating element supply voltage and can be activated during certain periods of time. The configuration with a secondary boost stage and a main boost stage as provided herein can be provided, wherein in particular, in some embodiments, the activation of the secondary boost stage during certain periods of time is used to supply voltage to the operating element.

Various embodiments of the timing circuit are provided herein. Particularly interesting is the use of a voltage monitoring circuit as provided herein, wherein a delay circuit of the voltage monitoring circuit is used for connection during certain periods of time. The timing circuit can therefore be implemented using particularly simple means.

It can also be possible to disconnect the boost arrangement from the operating element, thus avoiding premature discharging of the energy store.

According to various embodiments, a motor vehicle locking system comprising a drive having an electric drive motor for providing a motorized locking function for an adjustable closure element of a motor vehicle and a proposed control arrangement is provided. Reference may be made to all of the statements regarding the proposed control arrangement.

In various embodiments, a motor vehicle lock for the closure element of the motor vehicle is further provided, wherein the electric drive is provided for the motorized lifting of the pawl of the motor vehicle lock. The proposed solution can here take account of the special security requirements for motor vehicle locks.

Various embodiments provide a configuration of the motor vehicle locking system, wherein the control arrangement is integrated in the motor vehicle lock. Accordingly, the motor vehicle lock is set up for the emergency energy supply for the operating element which is provided, for example, in a door handle.

According to various embodiments, a method for operating a motor vehicle locking system is provided. It is important that the control arrangement has a timing circuit which is used in the emergency mode to connect an operating element supply voltage from the energy store to the operating element during certain periods of time. Reference may be made to all the statements regarding the proposed control arrangement and the proposed motor vehicle locking system.

Various embodiments provide a control arrangement for operating a motor vehicle locking system, wherein the motor vehicle locking system has a drive having an electric drive motor, wherein the control arrangement, in response to detection of an operating event by means of an operating element, controls the drive to provide a motorized locking function for an adjustable closure element of the motor vehicle, wherein the control arrangement has an electrical energy store, wherein the energy store provides an electrical energy store voltage for providing an electrical emergency supply voltage for the electric drive in an emergency mode, in particular if a normal supply voltage for the motor vehicle fails, wherein the control arrangement has a timing circuit which in the emergency mode connects an operating element supply voltage from the energy store to the operating element during certain periods of time.

In various embodiments, the energy store has at least one capacitor, such as at least one double-layer capacitor, and a boost arrangement which is connected downstream of the at least one capacitor and in the emergency mode boosts the capacitor voltage of the at least one capacitor to the emergency supply voltage.

In various embodiments, the timing circuit in the emergency mode connects the capacitor voltage as the operating element supply voltage to the operating element during certain periods of time. In some embodiments, the control arrangement activates the boost arrangement to provide the emergency supply voltage in response to detection of the operating event.

In various embodiments, the timing circuit in the emergency mode activates the boost arrangement during certain periods of time, and in that the boost arrangement provides the operating element with the operating element supply voltage when activated.

In various embodiments, the boost arrangement has a secondary boost stage and a main boost stage, in that the secondary boost stage of the main boost stage can be connected upstream in such a manner that the secondary boost stage boosts the capacitor voltage to at least one threshold voltage of the main boost stage provided for starting up the main boost stage, and in that the main boost stage boosts the capacitor voltage to the emergency supply voltage. In some embodiments, the control arrangement, in response to detection of the operating event, connects the secondary boost stage upstream of the main boost stage for starting up the main boost stage.

In various embodiments, the timing circuit in the emergency mode activates the secondary boost stage during certain periods of time, and in that the secondary boost stage provides the operating element with the operating element supply voltage when activated.

In various embodiments, the timing circuit has a clock generator and a switching element, in particular a logic gate, which is time-controlled by the clock generator and connects the operating element supply voltage, for connecting the operating element supply voltage during certain periods of time. In some embodiments, the clock generator is configured as an integrated and/or discrete circuit, in particular with a flip-flop, a relaxation oscillator, a comparator, an operational amplifier and/or an integrated module with at least one, in particular discrete, RC circuit.

In various embodiments, the timing circuit has a voltage monitoring circuit with a delay circuit, and in that the voltage monitoring circuit is interconnected for the purpose of connecting the operating element supply voltage during certain periods of time.

In various embodiments, the timing circuit has a delay circuit which causes the connection of the operating element supply voltage during certain periods of time. In some embodiments, the delay circuit has a delay element for activating a self-latching device of the boost arrangement and a further delay element for deactivating the self-latching device.

In various embodiments, the control arrangement has a microcontroller for controlling the drive. In some embodiments, the microcontroller provides the timing circuit or in that the control arrangement in the emergency mode provides the microcontroller with the emergency supply voltage in response to detection of the operating event.

In various embodiments, the control arrangement, in the absence of the operating element supply voltage, disconnects the boost arrangement, in particular the secondary boost stage, from the operating element.

Various embodiments provide a motor vehicle locking system comprising a drive having an electric drive motor for providing a motorized locking function for an adjustable closure element of a motor vehicle and a control arrangement as described herein, in some embodiments further comprising an operating element for detecting the operating event.

In various embodiments, a motor vehicle lock is provided for the closure element of the motor vehicle, in that the motor vehicle lock is equipped with a lock latch for the holding engagement with a locking part and a pawl assigned to the lock latch, and in that the electric drive is provided for the motorized lifting of the pawl. In some embodiments, the control arrangement is integrated in the motor vehicle lock.

Various embodiments provide a method for operating a motor vehicle locking system, wherein the motor vehicle locking system has a drive having an electric drive motor, wherein a control arrangement, in response to detection of an operating event by means of an operating element, is used to control the drive to provide a motorized locking function for an adjustable closure element of the motor vehicle, wherein the control arrangement has an electrical energy store, wherein the energy store is used to provide an electrical energy store voltage for providing an electrical emergency supply voltage for the electric drive in an emergency mode, in particular if a normal supply voltage for the motor vehicle fails, wherein the control arrangement has a timing circuit which is used in the emergency mode to connect an operating element supply voltage from the energy store to the operating element during certain periods of time.

### BRIEF DESCRIPTION OF THE DRAWINGS

Various aspects are explained in more detail below with reference to a drawing that merely illustrates exemplary embodiments. In the drawing:

FIG. 1 shows a schematic, perspective representation of a motor vehicle having a proposed motor vehicle locking system and a motor vehicle lock having a proposed control arrangement in a partially dismantled side view,

FIG. 2 a), b) show schematic representations of configurations of the proposed control arrangement, and

FIG. 3 a), b) show schematic representations of configurations of the proposed control arrangement.

### DETAILED DESCRIPTION

Various embodiments relate to a control arrangement 1 for operating a motor vehicle locking system 2. The motor vehicle locking system 2 has a drive 3 having an electric drive motor 4. The control arrangement 1, in response to detection of an operating event by means of an operating element 5, controls the drive 3 to provide a motorized locking function for an adjustable closure element 6 of the motor vehicle 7.

In the present case, the term “drive motor” 4 covers all types of electrical actuators, in particular rotary and linear actuators. In various embodiments, the drive motor 4 is a rotary electric motor which can be configured as a brush-type DC motor or as a brushless DC motor.

In the normal mode, the drive 3 can be fed from a normal supply voltage, such as from a supply voltage of the electrical system 8 of the motor vehicle 7, which is provided by the central battery of the motor vehicle 7. The central battery can be the battery that provides the electrical energy required for starting the motor vehicle 7 and/or for driving the motor vehicle 7.

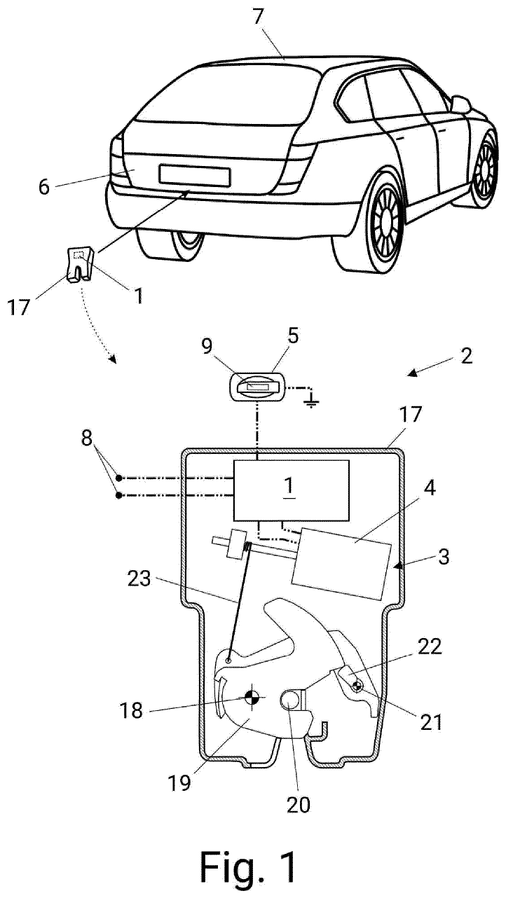

A motorized locking function should be understood as meaning that the adjustable closure element 6 of the motor vehicle 7 is adjusted, opened or closed, and/or locked or unlocked, directly or indirectly by a movement generated by the electric drive 3. With regard to the configuration of the closure element 6, reference may be made to the introductory statements, wherein in the present case FIG. 1 shows the method of operation of the motor vehicle locking system 2 for a closure element 6 configured as a tailgate. However, all statements also apply to all other types of closure elements 6 of the motor vehicle 7.

The control arrangement 1 here has control electronics for implementing the control tasks arising in connection with the motorized locking functions and is set up to control the electric drive 3. The operating event is transmitted in particular as an operating signal from the operating element 5 to the control arrangement 1. In various embodiments, the operating element 5, as shown in FIG. 1, is configured as a door handle which is manually actuated, for example during the operating event.

In various embodiments, the operating element 5 has a sensor device 9 which makes it possible to detect at least one part of the operating event. In various embodiments, the sensor device 9 serves to detect an electronic key of the motor vehicle 7, which is carried out, for example, using wireless communication via radio, BLE, NFC or the like. The electronic key can be checked in parallel with the detection of manual actuation of an operating element 5. For example, the operating event is deemed to have been detected when both the door handle is manually actuated, for example touched or pulled, and an electronic key is detected.

It is also conceivable for the sensor device 9 to detect a manual action by the operator, such as a touch, approach or operator gesture, on the motor vehicle 7. Examples of such sensor devices 9 include capacitive sensors, radar sensors and/or optical sensors, in particular on operating elements 5 of the motor vehicle 7.

The control arrangement 1 has an electrical, in some embodiments rechargeable, energy store 10. The energy store 10 provides an electrical energy store voltage for providing an electrical emergency supply voltage for the electric drive 3 in an emergency mode, in particular if a normal supply voltage for the motor vehicle 7 fails. In the present case, the motorized locking function can be guaranteed even in the emergency mode on the basis of the emergency supply voltage.

It is now essential that the control arrangement 1 has a timing circuit 11 which in the emergency mode connects an operating element supply voltage from the energy store 10 to the operating element 5 during certain periods of time.

The timing circuit 11 causes time-controlled connection of the operating element supply voltage on the basis of the energy store 10 and thus an emergency energy supply for the operating element 5. The operating element supply voltage is used in the emergency mode to detect the operating event. In particular, it is hereby possible to use the operating element 5 as in the normal mode in the periods of time in which connection takes place. However, limited use of the operating element 5, for example in an energy-saving mode of the operating element 5, is also conceivable.

The connection is carried out in this case during certain periods of time, thus providing in the emergency mode both periods of time in which the operating element supply voltage is connected and periods of time in which no supply voltage is effected for the operating element 5 by the energy store 10. The connection during certain periods of time is carried out by polling the operating element 5, wherein the operating element supply voltage can be connected cyclically.

Cycle times (the period between the start of a connection process and the start of the next connection process) can be here between 100 ms and 1000 ms, or 400 ms to 600 ms. A connection process can take place in each case for a switch-on duration of 10 ms to 100 ms, or 40 ms to 60 ms.

The manner of connection during certain periods of time, in particular the cycle time and/or switch-on duration, can be constant or depend on further boundary conditions. In one configuration, the operating element 5 is diagnosed by means of the control arrangement 1, wherein in particular a “hanging” position of the operating element 5 is detected. If, for example, continuous actuation for a predefined minimum period is detected, an incorrect operating signal can be assumed. In response to this, the connection during certain periods of time can be carried out with a shorter cycle time and/or switch-on duration or deactivated altogether.

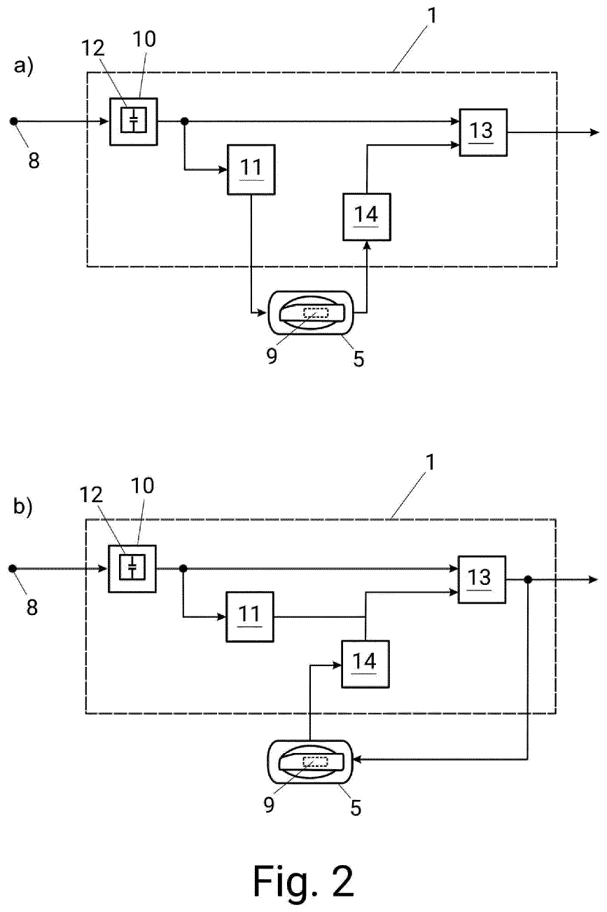

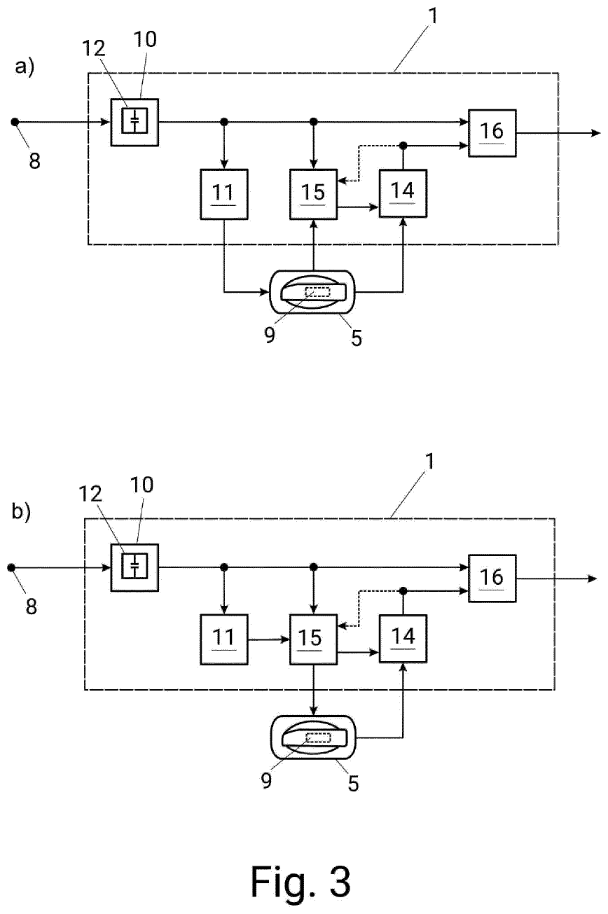

FIGS. 2 and 3 show schematic representations of configurations of the control arrangement 1. In various embodiments, it is provided that the energy store 10 has at least one capacitor 12. The energy store 10 can have exactly one capacitor 12, as shown. In a further configuration, a plurality of capacitors are provided and are fundamentally electrically connected in parallel and/or in series. In various embodiments, the plurality of capacitors are at least partially connected in series for providing the capacitor voltage.

In various embodiments, at least one double-layer capacitor is provided. A double-layer capacitor is an electrochemical energy store 10. The energy is stored in an electrochemical double layer, also known as the “Helmholtz layer”. Such a double-layer capacitor is also referred to as a “supercapacitor”, “supercap”, “ultracap” or the like.

In various embodiments, a boost arrangement 13 which is connected downstream of the at least one capacitor 12 and in the emergency mode boosts the capacitor voltage of the at least one capacitor 12 to the emergency supply voltage is provided. The emergency supply voltage can therefore be selected to be higher than the capacitor voltage and in particular can be selected according to the normal supply voltage. In the emergency mode, the capacitor voltage can be applied to an input of the boost arrangement 13 and is boosted to the emergency supply voltage at an output of the boost arrangement 13.

As shown in FIG. 2a) and FIG. 3a) and provided in various configurations, the timing circuit 11 in the emergency mode can connect the capacitor voltage as the operating element supply voltage to the operating element 5 during certain periods of time. Activation of the boost arrangement 13 is therefore not absolutely necessary to supply voltage to the operating element 5 and may not happen.

It is also conceivable to dispense with a boost arrangement 13 of the energy store 10, such as in connection with a series circuit comprising a plurality of capacitors, the capacitor voltage of which is sufficient to supply the operating element 5. In principle, the operating element 5 may also have a boost converter in order to boost the capacitor voltage connected as the operating element supply voltage.

When using the boost arrangement 13, provision can be made in various configurations for the control arrangement 1 to activate the boost arrangement 13 for providing the emergency supply voltage in response to detection of the operating event. The boost arrangement 13 is therefore activated when required if the drive 3 is intended to be controlled. As shown in FIG. 2a), a self-latching device 14 may be provided for the boost arrangement 13 and keeps the boost arrangement 13 active at least for the period in which the drive 3 is being controlled. For example, with the activation of the boost arrangement 13, a control unit for controlling the drive 3, for example a microcontroller, is also supplied with the emergency supply voltage.

In the configuration which is shown in FIG. 2b), provision is made for the timing circuit 11 in the emergency mode to activate the boost arrangement 13 during certain periods of time and for the boost arrangement 13 to provide the operating element 5 with the operating element supply voltage when activated.

Consequently, the operating element 5 can also be provided with an operating element supply voltage that is increased compared to the capacitor voltage, wherein the boost arrangement 13 is assigned a dual function. In various embodiments, the self-latching device 14 of the boost arrangement 13 is activated or deactivated during certain periods of time via the timing circuit 11 for the purpose of providing the operating element supply voltage. If the operating event is detected by means of the operating element 5, the self-latching device 14 can in turn remain activated in order to supply voltage to the drive 3.

FIG. 3 shows potential configurations of the control arrangement 1, wherein the boost arrangement 13 has a secondary boost stage 15 and a main boost stage 16. The secondary boost stage 15 can be connected upstream of the main boost stage 16 in such a way that the secondary boost stage 15 boosts the capacitor voltage to at least one threshold voltage of the main boost stage 16 provided for starting up the main boost stage 16. The threshold voltage provided for starting up is understood as meaning a minimum electrical voltage required to start the normal mode of the main boost stage 16. The threshold voltage provided for starting up the main boost stage 16 is provided in particular for operating a switching element, not shown, for instance a MOSFET, of the main boost stage 16. A self-latching device 14 can be provided here for the main boost stage 16 and/or the secondary boost stage 15.

The main boost stage 16 boosts the capacitor voltage to the emergency supply voltage. The secondary boost stage 15, which can be connected upstream of the main boost stage 16, can be additionally and specifically used here when starting up the main boost stage 16 to ensure operation of the main boost stage 16. The actual boosting of the energy store voltage to the emergency supply voltage is, however, carried out here, in some embodiments exclusively, via the main boost stage 16.

In various embodiments, provision is made for the control arrangement 1 to connect the secondary boost stage 15 upstream of the main boost stage 16 in response to detection of the operating event in order to activate the main boost stage 16. Accordingly, the emergency supply voltage can be supplied to the drive 3 by means of the main boost stage 16 for the purpose of carrying out the motorized locking function.

Basically, as shown in FIG. 3a), the capacitor voltage can be supplied to the operating element 5 during certain periods of time. In the further configuration shown in FIG. 3b), provision is made for the timing circuit 11 in the emergency mode the secondary boost stage 15 to provide the operating element 5 with the operating element supply voltage. The secondary boost stage 11 can be operated continuously for this purpose and in particular can supply a microcontroller of the control arrangement 1 in the emergency mode. It is also conceivable to activate the secondary boost stage 15 only during certain periods of time in order to provide the operating element 5 with the operating element supply voltage.

In addition to providing the threshold voltage of the main boost stage 16, the secondary boost stage 15 is thus additionally used for the emergency energy supply for the operating element 5. It is particularly advantageous in this case that the main boost stage 16 for supplying the operating element 5 can initially remain deactivated.

In various configurations, provision is made for the timing circuit 11 to have a clock generator and a switching element, in particular a logic gate, which is time-controlled by the clock generator and connects the operating element supply voltage, for connecting the operating element supply voltage during certain periods of time.

In principle, the clock generator can be constructed as an integrated and/or discrete circuit. The timing circuit 11 can be designed with a flip-flop, in particular an astable flip-flop, in order to implement the time control mentioned. A relaxation oscillator may also be provided, wherein, for example, an RC circuit is connected to a Schmitt trigger. The output signal from the Schmitt trigger can be supplied in this case to the switching element, in particular the logic gate. In addition, an RC circuit can be combined with a comparator or an operational amplifier in the timing circuit 11. An integrated module such as the NE555 can also be used as a clock generator.

In this case, the timing circuit 11 can be configured with at least one, in particular discrete, RC circuit. With the use of a discrete RC circuit, switching frequencies of the timing circuit 11 and thus the cycle time and cycle duration of the connection process can be parameterized.

In various configurations, provision is made for the timing circuit 11 to have a voltage monitoring circuit with a delay circuit, and for the voltage monitoring circuit to be interconnected for the purpose of connecting the operating element supply voltage during certain periods of time. Here, the functionality of a delay circuit that is provided in components for monitoring the voltage is used in the present case as the timing circuit 11.

In particular, for an extensive or complete discrete structure of the timing circuit 11, the timing circuit 11 may have a delay circuit which causes the operating element supply voltage to be connected during certain periods of time. The delay circuit here has at least one RC element and in particular a switching element.

The delay circuit can be used to control the self-latching device 14 that has already been mentioned. In various embodiments, the delay circuit has a delay element for activating a self-latching device 14 of the boost arrangement 13 and a further delay element for deactivating the self-latching device 14. The first delay element for activation can be used to define the cycle time. If the self-latching device 14 is activated and the operating element supply voltage is connected, a cycle duration is defined via the further delay element, after which the self-latching device 14 is deactivated again and thus the voltage supply for the operating element 5 is terminated. The first delay element for activation can then in turn take effect.

In various embodiments, provision is made for the control arrangement 1 to have a microcontroller for controlling the drive 3. It is conceivable for the microcontroller to provide the timing circuit 11 in this case. Alternatively, provision may be made for the control arrangement 1 to provide the emergency supply voltage to the microcontroller in the emergency mode in response to detection of the operating event. In order to save energy, the microcontroller can therefore be used in the emergency mode to control the drive 3 only when required.

Provision can also made here for the control arrangement 1, in the absence of the operating element supply voltage, to disconnect the boost arrangement 13, in particular the secondary boost stage 15, from the operating element 5. In various embodiments, a switching element is provided and is controlled by means of the timing circuit 11 in order to avoid further discharging of the energy store 10.

According to a further teaching, a motor vehicle locking system 2 comprising a drive 3 having an electric drive motor 4 for providing a motorized locking function for an adjustable closure element 6 of a motor vehicle 7 and a proposed control arrangement 1 is proposed.

Reference may be made to all of the statements regarding the proposed control arrangement 1. In various embodiments, the motor vehicle locking system 2 further comprises the operating element 5 for detecting the operating event, in particular with a sensor arrangement.

The sensor device 9 can serve to detect an electronic key of the motor vehicle 7, which is carried out, for example, as mentioned, using wireless communication via radio, BLE, NFC or the like.

The sensor device 9 may here comprise a subsystem, for example a sensor controller with a processor, which requires a start-up time. The switch-on duration of the operating element supply voltage can correspond to at least a period that is predefined for the sensor device 9 and is needed to provide an operating signal. The start-up time can also be taken into account for saving energy, wherein the microcontroller provided for receiving the operating signal is woken up by the control arrangement 1 only after a start-up time predefined for the sensor device 9 has elapsed or is only then supplied with the emergency supply voltage.

In various embodiments, the operating signal is transmitted via a supply line between the control arrangement 1 and the operating element 5, which also serves to supply the operating element supply voltage. For example, the operating signal is transmitted based on current modulation in the supply line.

Furthermore, a motor vehicle lock 17 can be provided for the closure element 6 of the motor vehicle 7. The motor vehicle lock 17 is shown in FIG. 1 in a partially dismantled side view and is equipped with a lock latch 19, which can be pivoted around a lock latch axis 18, for the holding engagement with a locking part 20 and a pawl 22 which is associated with the lock latch 19 and can be pivoted around a pawl axis 21. The locking part 20 can be a locking clip, a locking bolt or the like. For example, the motor vehicle lock 17 is arranged on a closure element 6, while the locking part 20 is arranged on the motor vehicle 7 in a manner fixed to the body.

The pawl 22 can be moved into a sunken position shown in FIG. 1, in which it holds the lock latch 19 in the closed position shown. Furthermore, the pawl 22 can be lifted in a motorized manner by means of the electric drive 3. For this purpose, the drive motor 4 can be connected to the pawl 22 by way of a drive cable 23. The motorized lifting of the pawl 22 corresponds in FIG. 1 to a pivoting of the pawl 22 in the clockwise direction around the pawl axis 21. In principle, the pawl 22 can also be part of a pawl system that consists of two or more sequentially arranged pawls and is associated with the lock latch 19. The motorized lifting of the pawl 22 is triggered in response to the operating event, for example manual actuation of the operating element 5 in conjunction with the electronic key check.

In various embodiments, the control arrangement 1 is integrated in the motor vehicle lock 17. The energy store 10 can be integrated in the motor vehicle lock 17 in this case and in particular can be arranged together with the mechanical lock components in a common housing. In addition to signal transmission, the connection between the motor vehicle lock 17 and the operating element 5 can also be set up to supply energy to the operating element 5 in the emergency mode.

In addition to or instead of the locking function of the motor vehicle lock 17 explained in more detail here, the motor vehicle locking system 2 may also have a drive arrangement for the motorized adjustment of an aforementioned closure element 6 of the motor vehicle 7, wherein the drive arrangement serves for motorized adjustment, in particular opening and/or closing, of the closure element 6. Further examples of locking functions are motorized adjustment of operating elements 5 and of interior elements and exterior elements of the motor vehicle 7 such as fan elements, interior mirrors, side mirrors, lighting or the like.

According to a further teaching, a method for operating a motor vehicle locking system 2 is proposed, wherein the motor vehicle locking system 2 has a drive 3 having an electric drive motor 4, wherein a control arrangement 1, in response to detection of an operating event by means of an operating element 5, is used to control the drive 3 to provide a motorized locking function for an adjustable closure element 6 of the motor vehicle 7, wherein the control arrangement 1 has an electrical energy store 10, wherein the energy store 10 is used to provide an electrical energy store voltage for providing an electrical emergency supply voltage for the electric drive 3 in an emergency mode, in particular if a normal supply voltage for the motor vehicle 7 fails.

It is essential in this case that the control arrangement 1 has a timing circuit 11 which is used in the emergency mode to connect an operating element supply voltage from the energy store 10 to the operating element 5 during certain periods of time. Reference may be made to all the statements regarding the proposed control arrangement 1 and the proposed motor vehicle locking system 2.

1. A control arrangement for operating a motor vehicle locking system, wherein the motor vehicle locking system has a drive having an electric drive motor, wherein the control arrangement, in response to detection of an operating event by means of an operating element, controls the drive to provide a motorized locking function for an adjustable closure element of the motor vehicle, wherein the control arrangement has an electrical energy store, wherein the energy store provides an electrical energy store voltage for providing an electrical emergency supply voltage for the electric drive in an emergency mode, wherein the control arrangement has a timing circuit which in the emergency mode connects an operating element supply voltage from the energy store to the operating element during certain periods of time.

2. The control arrangement according to claim 1, wherein the energy store has at least one capacitor and a boost arrangement which is connected downstream of the at least one capacitor and in the emergency mode boosts the capacitor voltage of the at least one capacitor to the emergency supply voltage.

3. The control arrangement according to claim 2, wherein the timing circuit in the emergency mode connects the capacitor voltage as the operating element supply voltage to the operating element during certain periods of time.

4. The control arrangement according to claim 2, wherein the timing circuit in the emergency mode activates the boost arrangement during certain periods of time, and wherein the boost arrangement provides the operating element with the operating element supply voltage when activated.

5. The control arrangement according to claim 2, wherein the boost arrangement has a secondary boost stage and a main boost stage, wherein the secondary boost stage of the main boost stage can be connected upstream in such a manner that the secondary boost stage boosts the capacitor voltage to at least one threshold voltage of the main boost stage provided for starting up the main boost stage, and wherein the main boost stage boosts the capacitor voltage to the emergency supply voltage.

6. The control arrangement according to claim 5, wherein the timing circuit in the emergency mode activates the secondary boost stage during certain periods of time, and wherein the secondary boost stage provides the operating element with the operating element supply voltage when activated.

7. The control arrangement according to claim 1, wherein the timing circuit has a clock generator and a switching element which is time-controlled by the clock generator and connects the operating element supply voltage, for connecting the operating element supply voltage during certain periods of time.

8. The control arrangement according to claim 1, wherein the timing circuit has a voltage monitoring circuit with a delay circuit, and wherein the voltage monitoring circuit is interconnected for the purpose of connecting the operating element supply voltage during certain periods of time.

9. The control arrangement according to claim 1, wherein the timing circuit has a delay circuit which causes the connection of the operating element supply voltage during certain periods of time.

10. The control arrangement according to claim 1, wherein the control arrangement has a microcontroller for controlling the drive.

11. The control arrangement according to claim 1, wherein the control arrangement, in the absence of the operating element supply voltage, disconnects the boost arrangement from the operating element.

12. A motor vehicle locking system comprising a drive having an electric drive motor for providing a motorized locking function for an adjustable closure element of a motor vehicle and a control arrangement according to claim 1.

13. The motor vehicle locking system according to claim 12, wherein a motor vehicle lock is provided for the closure element of the motor vehicle, wherein the motor vehicle lock is equipped with a lock latch for the holding engagement with a locking part and a pawl assigned to the lock latch, and in that the electric drive is provided for the motorized lifting of the pawl.

14. A method for operating a motor vehicle locking system, wherein the motor vehicle locking system has a drive having an electric drive motor, wherein a control arrangement, in response to detection of an operating event by an operating element, is used to control the drive to provide a motorized locking function for an adjustable closure element of the motor vehicle, wherein the control arrangement has an electrical energy store, wherein the energy store is used to provide an electrical energy store voltage for providing an electrical emergency supply voltage for the electric drive in an emergency mode, wherein the control arrangement has a timing circuit which is used in the emergency mode to connect an operating element supply voltage from the energy store to the operating element during certain periods of time.

15. The control arrangement according to claim 2, wherein at least one capacitor comprises at least one double-layer capacitor.

16. The control arrangement according to claim 3, wherein the control arrangement activates the boost arrangement to provide the emergency supply voltage in response to detection of the operating event.

17. The control arrangement according to claim 5, wherein the control arrangement, in response to detection of the operating event, connects the secondary boost stage upstream of the main boost stage for starting up the main boost stage.

18. The control arrangement according to claim 7, wherein the clock generator is configured as an integrated and/or discrete circuit.

19. The control arrangement according to claim 9, wherein the delay circuit has a delay element for activating a self-latching device of the boost arrangement and a further delay element for deactivating the self-latching device.

20. The control arrangement according to claim 10, wherein the microcontroller provides the timing circuit or in that the control arrangement in the emergency mode provides the microcontroller with the emergency supply voltage in response to detection of the operating event.
